(19) United States
(12) Patent Application Publication
(10) Pub. No.: US 2024/0001275 A1
(43) Pub. Date: Jan. 4, 2024

(54) FILTER GROUP

(71) Applicant: UFI INNOVATION CENTER S.R.L., Ala, Trento (IT)

(72) Inventor: Giorgio GIRONDI, Ala, Trento (IT)

(21) Appl. No.: 18/254,229

(22) PCT Filed: Nov. 18, 2021
(86) PCT No.: PCT/IB2021/060695

§ 371 Date: May 24, 2023

(30) Foreign Application Priority Data
Nov. 25, 2020 (IT) 102020000028424

(51) Int. Cl. B01D 46/12; B01D 46/00

(52) U.S. Cl. CPC B01D 46/12; B01D 46/0043; B01D 2277/10

(57) ABSTRACT

The invention is a filter group (1) comprising a filtration region (R) extending between an inlet area (IN) through which fluid to be filtered flows, and an outlet area (OUT) through which filtered fluid flows. The filter group (1) extends along a longitudinal axis (X-X), along a transverse axis (Y-Y) and, in height, along a vertical axis (V-V). Furthermore, the filter group (1) comprises: a filtering panel (3) extending with respect to an imaginary plane (F) and which may be crossed by the filtration fluid in a direction substantially orthogonal to the imaginary plane (F); —a baffle panel (4) impermeable to fluid; —an inlet chamber (5) defined between the filtering panel (3) and the baffle panel (4), wherein the inlet chamber (5) is open in a proximal region to the inlet area (IN) and is closed in a region which is proximal to the outlet area (OUT). The invention is a filter group (1) comprising a filtration region (R) extending between an inlet area (IN) through which fluid to be filtered flows, and an outlet area (OUT) through which filtered fluid flows. The filter group (1) extends along a longitudinal axis (X-X), along a transverse axis (Y-Y) and, in height, along a vertical axis (V-V). Furthermore, the filter group (1) comprises: a filtering panel (3) extending with respect to an imaginary plane (F) and which may be crossed by the filtration fluid in a direction substantially orthogonal to the imaginary plane (F); —a baffle panel (4) impermeable to fluid; —an inlet chamber (5) defined between the filtering panel (3) and the baffle panel (4), wherein the inlet chamber (5) is open in a proximal region to the inlet area (IN) and is closed in a region which is proximal to the outlet area (OUT). The invention is a filter group (1) comprising a filtration region (R) extending between an inlet area (IN) through which fluid to be filtered flows, and an outlet area (OUT) through which filtered fluid flows. The filter group (1) extends along a longitudinal axis (X-X), along a transverse axis (Y-Y) and, in height, along a vertical axis (V-V). Furthermore, the filter group (1) comprises: a filtering panel (3) extending with respect to an imaginary plane (F) and which may be crossed by the filtration fluid in a direction substantially orthogonal to the imaginary plane (F); —a baffle panel (4) impermeable to fluid; —an inlet chamber (5) defined between the filtering panel (3) and the baffle panel (4), wherein the inlet chamber (5) is open in a proximal region to the inlet area (IN) and is closed in a region which is proximal to the outlet area (OUT).

### FIELD OF APPLICATION

The present invention relates to a filter group for a fluid.

According to a preferred embodiment, the filter group is specifically suitable for performing air filtration operations.

The context in which the present invention pertains is that of filtering groups in the automotive field. In particular, it relates to those filtering groups which are connectable, by means of specific channels and specific manifolds, to operating groups of a vehicle or to specific spaces of the vehicle, so as to filter the fluid and prevent said operating groups or said spaces from being reached by fluids containing undesired particles.

Such filtering groups housed in a vehicle are required to be suitable for performing an effective and efficient filtration of the fluid, occupying a space as small as possible and avoiding obstructing the outflow of the fluid towards the operating group or the desired space.

In light of the above, it has been noted how, in order to have an effective and efficient filtration, the other needs of the technical field were not met. Conversely, when the filtering groups are created as compact as possible, they have filtering properties with low effectiveness and low efficiency, or they act as an obstacle to the outflow of the fluid.

### Solution of the Invention

The need is thus strongly felt to provide a filter group which is suitable for solving such an issue.

Precisely, it is the object of the present invention to provide a filter group for a fluid which has an effective and efficient filtering capacity, utilizing the spaces in a highly innovative manner and without acting as an obstacle to the outflow of the fluid. Therefore, by solving such an object, the filter group of the present invention is preferably particularly suitable for being applied to the automotive field, being suitable for being housable in the narrow spaces provided on a vehicle.

Such an object is achieved by the filter group claimed in claim 1.

The claims dependent on the aforesaid claims show preferred variants implying further advantageous aspects.

### DESCRIPTION OF THE DRAWINGS

Further features and advantages of the invention will become apparent from the description provided below of preferred exemplary embodiments thereof, given by way of non-limiting example, with reference to the accompanying drawings, in which:

FIGS. 1a, 1b, 1c and 1d show a diagram of a preferred embodiment of the filter group of the present invention, in a top perspective view with separate parts, a bottom perspective view with separate parts, a front view and a longitudinal sectional view, respectively;

FIGS. 2a, 2b, 2c and 2d show a diagram of a preferred embodiment of the filter group of the present invention, in a top perspective view with separate parts, a bottom perspective view with separate parts, a front view and a longitudinal sectional view, respectively;

FIGS. 3a, 3b, 3c and 3d show a diagram of a preferred embodiment of the filter group of the present invention, in a top perspective view with separate parts, a bottom perspective view with separate parts, a front view and a longitudinal sectional view, respectively;

FIGS. 4a, 4b, 4c and 4d show a diagram of a preferred embodiment of the filter group of the present invention, in a top perspective view with separate parts, a bottom perspective view with separate parts, a front view and a longitudinal sectional view, respectively;

FIGS. 5a, 5b, 5c and 5d show a diagram of a preferred embodiment of the filter group of the present invention, in a top perspective view with separate parts, a bottom perspective view with separate parts, a front view and a longitudinal sectional view, respectively;

FIGS. 6a, 6b, 6c and 6d show a diagram of a preferred embodiment of the filter group of the present invention, in a top perspective view with separate parts, a bottom perspective view with separate parts, a front view and a longitudinal sectional view, respectively;

FIGS. 7a, 7b, 7c and 7d show a diagram of a preferred embodiment of the filter group of the present invention, in a top perspective view with separate parts, a bottom perspective view with separate parts, a front view and a longitudinal sectional view, respectively;

FIGS. 8a, 8b, 8c and 8d show a diagram of a preferred embodiment of the filter group of the present invention, in a top perspective view with separate parts, a bottom perspective view with separate parts, a front view and a longitudinal sectional view, respectively;

FIGS. 9a and 9b show a diagram of a preferred embodiment of the filter group of the present invention, in a top perspective view with separate parts and a longitudinal sectional view, respectively;

FIGS. 10a and 10b show a diagram of a preferred embodiment of the filter group of the present invention, in a top perspective view with separate parts and a longitudinal sectional view, respectively;

FIG. 11 shows a diagram of a preferred embodiment of the filter group of the present invention, in a top perspective view with separate parts;

FIGS. 12a, 12b, 12c and 12d depict further diagrammatic embodiments of the filter group of the present invention;

FIGS. 13a, 13b, 13c, 13d, 13e and 13f show even further diagrammatic embodiments of the filter group of the present invention;

FIG. 14 shows a detailed embodiment of a filter group of the present invention, according to a preferred embodiment;

FIG. 15 depicts a detail of a further embodiment of the filter group of the present invention, according to a preferred embodiment;

FIGS. 16a and 16b depict further embodiments and some relative details of the filter group of the present invention, according to a preferred embodiment;

FIGS. 17a, 17b and 17c depict further embodiments and some relative details of the filter group of the present invention, according to a preferred embodiment;

FIGS. 18a, 18b and 18c depict further embodiments and some relative details of the filter group of the present invention, according to a preferred embodiment;

FIGS. 19a, 19b, 19c, 19d and 19e depict further embodiments and some relative details of the filter group of the present invention, according to a preferred embodiment.

### DETAILED DESCRIPTION

In the accompanying Figures, reference numeral 1 indicates a filter group in accordance with the present invention.

Said filter group 1 is crossable under filtration by a fluid.

Preferably, said filter 1 is crossable under filtration by air.

According to the present invention, the filter group 1 comprises a filtration region R in which the filtration of the fluid, and therefore the separation from the fluid of undesired substances or particles, occurs.

The filtration region R extends in length between an inlet area IN through which fluid to be filtered flows, and an outlet area OUT through which filtered fluid flows.

As shown in the diagrams and as widely described below, the filter group 1 of the present invention is suitable for being highly flexible in the design, construction, and manufacturing thereof, so as to allow the mutual positioning of the inlet area IN and outlet area OUT according to specific needs.

The filter group 1 extends along a longitudinal axis X-X, along a transverse axis Y-Y and along a vertical axis V-V.

In accordance with a preferred embodiment, the longitudinal axis X-X extends in a linear direction.

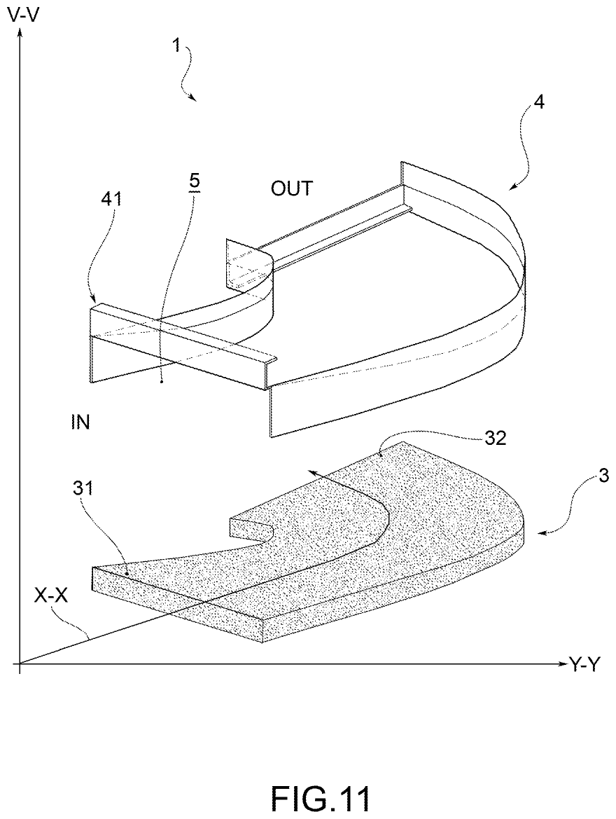

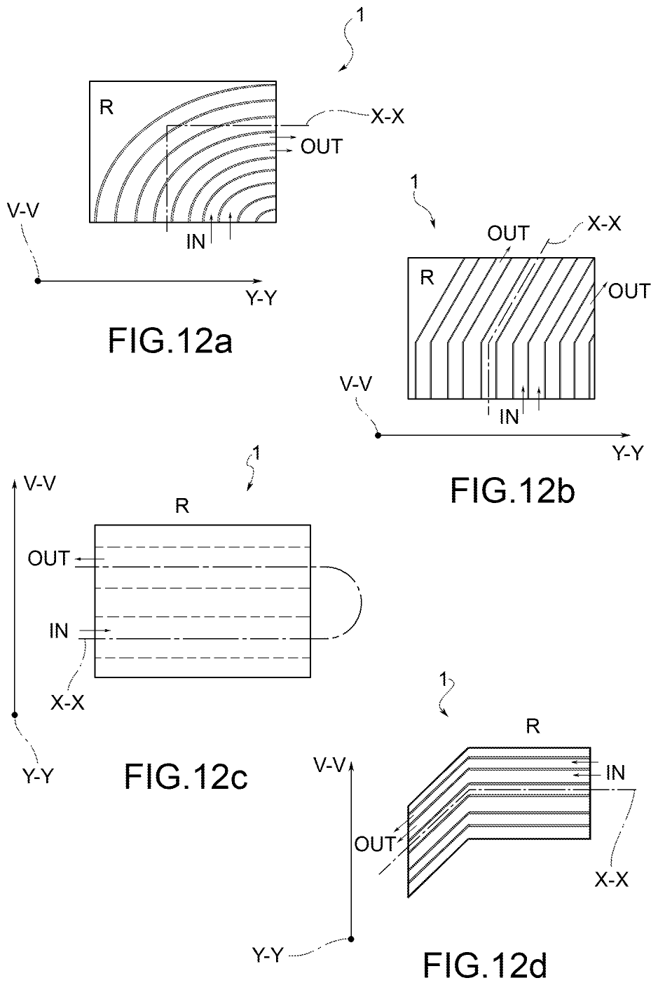

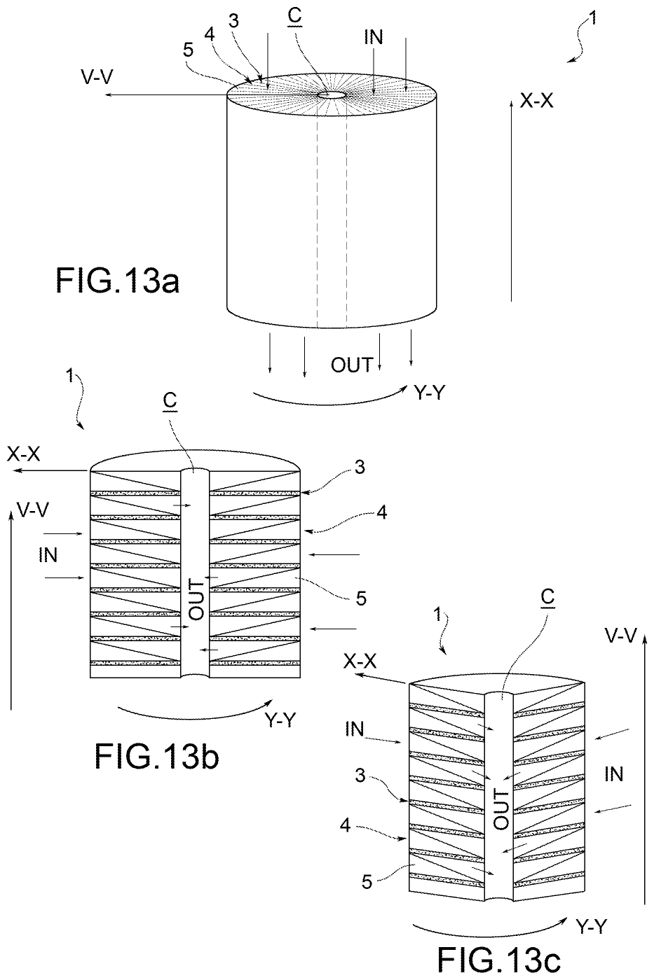

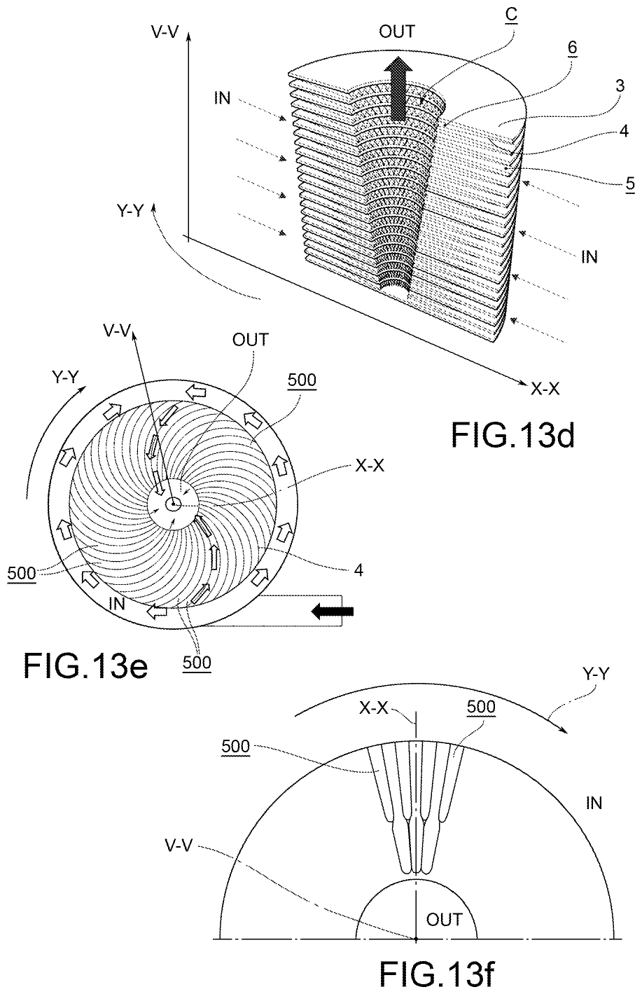

In accordance with a preferred embodiment, the longitudinal axis X-X extends in a curvilinear direction (as shown by way of example in FIG. 11, FIG. 12a and FIG. 13e).

In accordance with a preferred embodiment, the longitudinal axis X-X extends in a broken direction (as shown by way of example in FIG. 12b and FIG. 12d).

In accordance with a preferred embodiment, the longitudinal axis X-X extends in a mixed manner, having linear segments and curvilinear segments (as shown by way of example in FIG. 12c).

According to a preferred embodiment, the transverse axis Y-Y is transverse to the longitudinal axis Y-Y. Preferably, the transverse axis Y-Y is orthogonal to the longitudinal axis X-X.

In accordance with a preferred embodiment, the transverse axis Y-Y extends in a linear direction.

In accordance with a preferred embodiment, the transverse axis Y-Y extends in a curvilinear direction (as shown by way of example in FIGS. 13a, 13b, 13c, 13d, 13e and 13f).

In accordance with a preferred embodiment, the transverse axis Y-Y extends in a broken direction.

In accordance with a preferred embodiment, the transverse axis Y-Y extends in a mixed manner, having linear segments and curvilinear segments.

According to a preferred embodiment, the vertical axis V-V extends from the longitudinal axis X-X, transversely thereto. Preferably, it extends transversely to the longitudinal axis X-X and transversely to the transverse axis Y-Y. Preferably, the vertical axis V-V is orthogonal to an imaginary plane in which both the longitudinal axis X-X and the transverse axis Y-Y lie. In accordance with a preferred embodiment, the vertical axis V-V extends in a linear direction.

In accordance with a preferred embodiment, the vertical axis V-V extends in a curvilinear direction.

In accordance with a preferred embodiment, the vertical axis V-V extends in a broken direction.

In accordance with a preferred embodiment, the vertical axis V-V extends in a mixed manner, having linear segments and curvilinear segments.

According to a series of preferred embodiments, the filter group 1 has such a shape as to extend in length along said longitudinal axis X-X and said transverse axis Y-Y, for example, by positioning the inlet area IN and the outlet area OUT at two opposite ends along the longitudinal axis X-X, or by positioning the inlet area IN at a longitudinal end and the outlet area OUT at a transverse end.

According to a further preferred embodiment, the filter group 1 comprising a central cavity C and the filtration region R extends about the central cavity C. In other words, in such an embodiment, the filter group 1 has a substantially tubular shape, having a substantially cylindrical or conical or frustoconical shape (as shown by way of example in FIGS. 13a, 13b, 13c, 13d, 13e and 13f).

In accordance with such a preferred embodiment, in a first embodiment, the longitudinal axis X-X extends parallel along the tubular extension of the filter group 1, while the transverse axis Y-Y extends in a substantially circumferential direction, and the vertical axis V-V extends in a radial direction. Preferably, the inlet area IN and the outlet area OUT are positioned at two axial ends along the longitudinal axis X-X: the filter group 1 operates as an “axial filter”. In other words, in this embodiment, the inlet area IN and the outlet area OUT are positioned at two longitudinally opposite ends, i.e., mutually spaced apart along the longitudinal axis X-X. Such a first embodiment is shown as an example in FIG. 13a.

In accordance with the aforesaid preferred embodiment, in a second embodiment, the longitudinal axis X-X extends substantially radially with respect to the tubular extension of the filter group 1, while the transverse axis Y-Y extends in a substantially circumferential direction, and the vertical axis V-V extends parallel along the tubular extension of the filter group 1. Preferably, the inlet area IN and the outlet area OUT are positioned at two radial ends along the longitudinal axis X-X, i.e., at least one of the two areas corresponds to the central cavity C: the filter group 1 operates as a “radial filter”. Preferably, the outlet area OUT corresponds to the central cavity C, while the inlet area IN is radially spaced apart outside the tubular filter group 1: the filter group 1 operates as an outer-inner radial filter. Such a second embodiment is shown as an example in FIGS. 13b, 13c, 13d, 13e and 13f.

Preferably, in accordance with the embodiment with a “radial” filter which is crossable by the fluid from the outside to the inside, the inner cavity C delimits a fluid passage having a variable passage section.

Preferably, the inner cavity C delimits a fluid passage with an increasing passage section along the axis of the cavity itself. Preferably, said cavity is obtained by stacking filtering panels 3 and baffle panels 4 of a different annular shape.

Advantageously, this solution allows to facilitate the circulation of fluid through the filter group 1 in the distal portions from the outlet area, in particular in the distal portions from the axial end of the filter group 1 facing the outlet area, thus improving the distribution of the flow under filtration along the axis of the filter group 1.

In accordance with the present invention, the filter group 1 comprises:
a filtering panel 3 which is crossable by the fluid under filtration in a direction substantially orthogonal to the extension thereof;
a baffle panel 4 which is impermeable to fluid;
an inlet chamber 5 defined between the filtering panel 3 and the baffle panel 4.

In accordance with the present invention, the filtering panel 3 extends with respect to an imaginary plane F which is crossable by the fluid under filtration in a direction substantially orthogonal to the imaginary plane F.

According to a preferred embodiment, the filtering panel 3 extends in a substantially planar manner.

According to a preferred embodiment, both the longitudinal axis X-X and the transverse axis Y-Y lie on said imaginary plane F, therefore the shape of the imaginary plane F (i.e., linear or curvilinear or serrated) is a function of the shape of the longitudinal axis X-X and the transverse axis Y-Y.

Therefore, the filtering panel 3 is crossable under filtration by the fluid in the thickness thereof. Preferably, the filtering panel 3 is crossable under filtration by the fluid in a direction substantially parallel to the vertical axis V-V.

According to a preferred embodiment of the present invention, the inlet chamber 5 is open in a region which is proximal to the inlet area IN and is closed in a region which is proximal to the outlet area OUT.

Preferably, the inlet chamber 5 is thus open only and exclusively in a region which is proximal to the inlet area IN, while it is closed in a region which is proximal to the outlet area OUT so that the fluid is forced to cross the filtering panel 3.

According to a preferred embodiment of the solution of the present invention, the coupling of the filtering panel 3 to the baffle panel 4 is such as to define an inlet chamber 5 shaped so as to comprise a first inlet area I1 corresponding to a first section substantially orthogonal to the imaginary plane F in a region which is proximal to the inlet area IN and a second inlet area I2 corresponding to a second section substantially orthogonal to the imaginary plane F in a region which is distal from the inlet area IN.

Preferably, the first inlet area I1 is greater than the second inlet area I2.

Preferably, the inlet chamber 5 has a decreasing passage section with a monotonous course along the extension thereof.

In other words, the coupling of the filtering panel 3 to the baffle panel 4 is such as to define an inlet chamber 5 having a larger passage section close to the inlet area IN and a smaller passage section close to the outlet area OUT.

As shown in the accompanying tables, and amply described below, this is achieved by particular shapes of the baffle panel 4, for example, comprising specific portions with a tapered course or comprising a greater number of components suitable for allowing the flow of the fluid in a region which is proximal to the inlet area IN with respect to the number of components present in a region which is proximal to the outlet area OUT.

Such a particular preferred embodiment is such as to allow a better access of the fluid into the inlet chamber and is such as to make the filtering panel 3 work as homogeneously as possible.

In accordance with a preferred embodiment, the filter group 1 comprises a pair of baffle panels 4 which are impermeable to the fluid, positioned at the two opposite faces of the filtering panel 3.

Preferably, the first baffle panel 4 and the filtering panel 3 define said inlet chamber 5.

Preferably, the filtering panel 3 and the second baffle panel 4 define an outlet chamber 6 which is open in a region proximal to the outlet area OUT and is closed in a region proximal to the inlet area IN.

According to a preferred embodiment, the filter group 1 comprises a pair of filtering panels 3, wherein the baffle panel 4 is positioned in the space between two filtering panels so that said inlet chamber 5 is defined between the first filtering panel 3 and the baffle panel 4, and so that an outlet chamber 6 is defined between the second filtering panel 3 and the baffle panel 4.

Preferably, also in such an embodiment, said outlet chamber 6 is open in a region which is proximal to the outlet area OUT and is closed in a region which is proximal to the inlet area IN.

According to a preferred embodiment, the coupling of the filtering panel 3 to the baffle panel 4 is such as to define an outlet chamber 6 shaped so as to comprise a first outlet area O1 corresponding to a first section substantially orthogonal to the imaginary plane F in a region which is proximal to the inlet area IN and a second outlet area O2 corresponding to a second section substantially orthogonal to the imaginary plane F in a region which is proximal to the outlet area OUT.

Preferably, the first outlet area O1 is smaller than the second outlet area O2.

Preferably, the outlet chamber 6 has an increasing passage section with a monotonous course along the extension thereof.

In other words, the coupling of the filtering panel 3 to the baffle panel 4 is such as to define an outlet chamber 6 having a smaller passage section close to the inlet area IN and a larger passage section close to the outlet area OUT.

As shown in the accompanying tables, and widely described below, this is achieved by particular shapes of the baffle panel 4, for example, comprising specific portions with a tapered course or comprising a greater number of components suitable for allowing the flow of the fluid in a region which is proximal to the outlet area OUT with respect to the number of components present in a region which is proximal to the inlet area IN.

Such a particular preferred embodiment is such as to improve the circulation of the filtered fluid exiting from the filtering panel 3, as well as such as to let said filtering panel 3 work as homogeneously as possible. In accordance with certain embodiments, the outlet chamber 6 is complementary to the inlet chamber 5.

In accordance with such a preferred embodiment, in a manner complementary to the inlet channels 500, described below, the baffle panel 4 delimits specific, complementary, outlet channels 600.

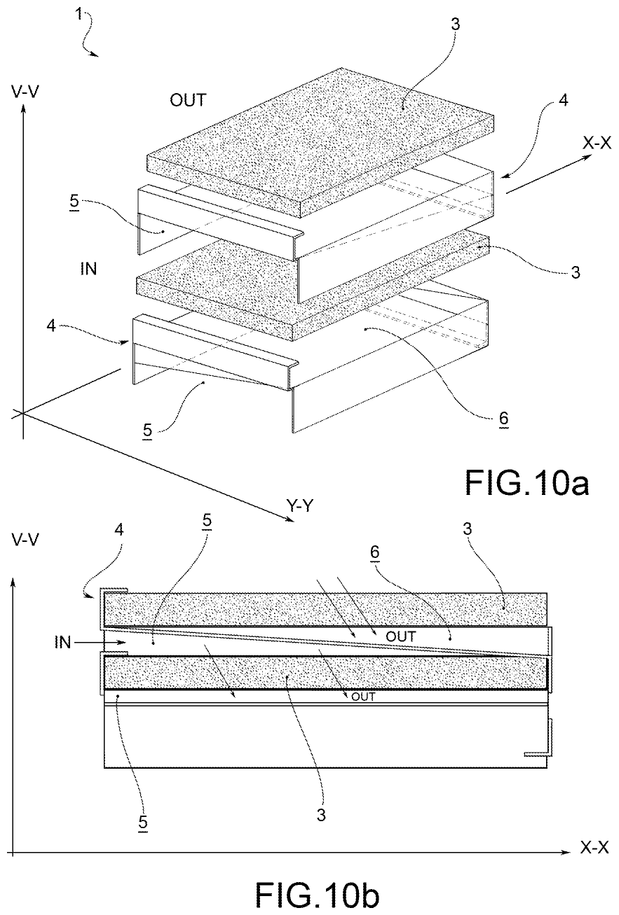

According to a preferred embodiment, the inlet area IN and the outlet area OUT are spatially positioned as a function of the shape or of the position of the baffle panel 4 which delimits the outlet chamber 6 (as diagrammatically exemplified in FIGS. 10a and 10b).

In accordance with a preferred embodiment of the present invention, the filter group 1 comprises a plurality of filtering panels 3 and a plurality of baffle panels 4 stacked parallel to the direction of the vertical axis V-V.

In accordance with a preferred embodiment, the filter group 1 comprises a plurality of filtering panels 3 and a plurality of baffle panels 4 stacked parallel to the direction of the vertical axis V-V so as to form a plurality of inlet chambers 5 and a plurality of outlet chambers 6 crossed in parallel by the working fluid.

According to a preferred embodiment, the inlet chambers 5 and the outlet chambers 6 have the same height.

According to a preferred embodiment, the filter group 1 comprises a plurality of inlet chambers 5 and a plurality of outlet chambers 6 having different heights.

In accordance with a preferred embodiment, the filter group 1 comprises a plurality of filtering panels 3 and a plurality of baffle panels 4 stacked parallel to the direction of the vertical axis V-V so as to form a plurality of inlet chambers 5 and outlet chambers 6 arranged so as to form two filtering portions which are crossable in series by the working fluid. In particular, each filtering portion comprises a plurality of inlet chambers 5 and outlet chambers 6 crossed in parallel by the working fluid.

In other words, a plurality of filtering panels 3 and baffle panels 4 are preferably alternated along said vertical axis V-V so as to identify a multiplicity of inlet chambers 5 and outlet chambers 6.

The term “panel” in the present description means a component which mainly extends along two preferential directions.

In accordance with a preferred embodiment, the filtering panel 3 and the baffle panel 4 have the same substantially square shape. In this case, the filter group 1 resulting from the stacking of a plurality of filtering panels 3 and baffle panels 4 has a cubic shape.

In accordance with a preferred embodiment, the filtering panel 3 and the baffle panel 4 have the same substantially rectangular shape. In this case, the filter group 1 resulting from the stacking of a plurality of filtering panels 3 and baffle panels 4 has a parallelepiped shape.

In accordance with a preferred embodiment, the filtering panel 3 and the baffle panel 4 have the same discoidal shape. In this case, the filter group 1 resulting from the stacking of a plurality of filtering panels 3 and baffle panels 4 has a cylindrical shape.

In accordance with a preferred embodiment, the filtering panel 3 is a sheet-like filtering medium made of a porous filtering material.

According to a preferred embodiment, the filtering panel 3 is a filtering medium made of non-woven fabric.

Preferably, the filtering panel 3 is made from a non-woven fabric comprising polyester and/or polypropylene and/or polyamide and/or polyacrylate and/or viscose and/or rayon fibers and/or any combination thereof.

Preferably, the filtering panel 3 is a depth filtering septum made in the form of a flat sheet.

In accordance with a preferred embodiment, the filtering panel 3 is made of a non-woven fabric having a permeability between 150 and 950 mm/s, preferably between 550 and 700 mm/s (measured at 200 Pa).

Preferably, the filtering panel 3 is single-layer.

Preferably, the filtering panel 3 is of the multi-layer type.

Preferably, the filtering panel 3 comprises a first filtering layer of permeable non-woven fabric, with a permeability between 750 and 900 mm/s (at 200 Pa), coupled to a second filtering layer of non-woven fabric with a lower permeability, between 150 and 200 mm/s (at 200 Pa).

In accordance with a preferred embodiment, the filtering panel 3 comprises a third filtering layer positioned between the two outer layers and having an intermediate permeability, between 250 and 300 mm/s (at 200 Pa).

In accordance with a preferred embodiment, the filtering panel 3 contains adsorbent substances therein, such as activated carbons and/or ion exchange resins and/or zeolites.

Preferably, the filtering panel 3 comprises a filtering layer suitable for filtering particles and an adsorbent layer suitable for adsorbing gaseous contaminants. Preferably, the filtering layer is positioned upstream of the adsorbent layer with respect to the fluid crossing direction. Preferably, the adsorbent layer comprises a plurality of adsorbent substances such as activated carbons and ion exchange resins.

According to a preferred embodiment, the filtering panel 3 comprises a filtering layer suitable for filtering particles and a plurality of adsorbent layers comprising respective adsorbent elements.

According to a preferred embodiment, the filtering panel 3 has an ISO5011 filtering efficiency greater than 99% (ISO FINE).

According to a preferred embodiment, the filtering panel 3 has a thickness between 0.5 and 3 millimeters (measured according to ASTM D5729-1997), preferably the filtering panel 3 has a thickness between 1.5 millimeters and 2.8 millimeters.

In accordance with a preferred embodiment, the baffle panel 4 is a sheet-like element made of a material belonging to the family of plastic materials.

In accordance with a preferred embodiment, the baffle panel 4 contains adsorbent substances therein, for example, activated carbons.

According to a preferred embodiment, the baffle panel 4 has a thickness of less than 1, preferably between and 0.5 millimeters, preferably the baffle panel has a thickness of 0.2 millimeters.

According to a preferred embodiment, the baffle panel 4 is worked by means of a thermoforming process.

In accordance with a preferred embodiment, the filtering panel 3 comprises an inlet filter edge 31 and an outlet filter edge 32.

Furthermore, the filtering panel 3 comprises side edges 34 which connect the inlet filter edge 31 to the outlet filter edge 32.

Preferably, the inlet filter edge 31 is proximal to, preferably faces, the inlet area IN, and the outlet filter edge 32 is proximal to, preferably faces, the outlet area OUT.

Similarly, the baffle panel 4 preferably comprises an inlet baffle edge 41 and an outlet baffle edge 42.

Furthermore, the baffle panel 4 comprises side baffle surfaces 44.

Preferably, the inlet baffle edge 41 is proximal to, preferably faces, the inlet area IN and the outlet baffle edge 42 is proximal to, preferably faces, the outlet area OUT.

In accordance with a preferred embodiment, said outlet baffle edge 42 sealingly engages the filtering panel 3.

Preferably, the outlet baffle edge 42 sealingly engages the outlet filter edge 32 closing the inlet chamber 5.

According to a preferred embodiment, the outlet baffle edge 42 comprises an outlet edge portion 420 comprising a outlet housing cavity 421 in which the outlet filter edge 32 is housed.

In particular, the outlet filter edge 32 is preferably clamped into the outlet housing cavity 421.

Therefore, the outlet edge portion 420 preferably closes and blocks the flow of the fluid crossing the thickness of the filtering panel 3.

In accordance with other embodiments, the baffle panel 4 sealingly engages the filtering panel 3, with the purpose of defining the outlet chamber 6, even by means of the inlet baffle edge 41.

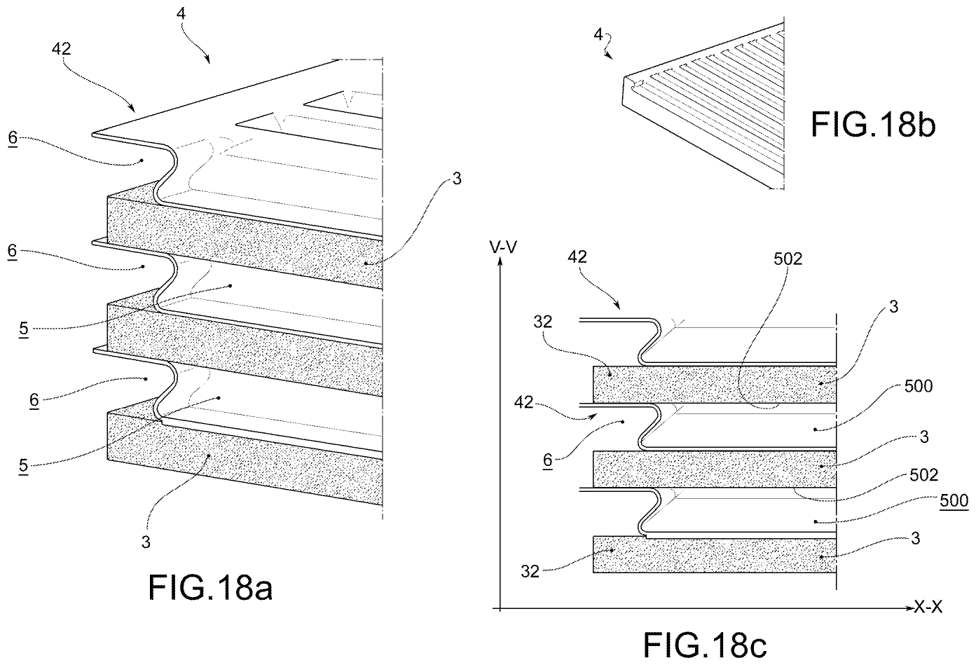

In accordance with a preferred embodiment, as shown by way of example in FIGS. 18a, 18b and 18c, the baffle panel 4 comprises, in a region which is proximal to the outlet area OUT, a portion shaped so as to have the sealing engagement on the first filtering panel 3 superimposed, along the vertical axis, to the sealing engagement on the second filtering panel 3, thus fluidly closing the inlet chamber 5.

According to a preferred embodiment, the inlet baffle edge 41 engages the filtering panel 3 with an inlet edge portion 410 comprising an inlet housing cavity 411 in which the inlet filter edge 31 of said filtering panel is housed 3.

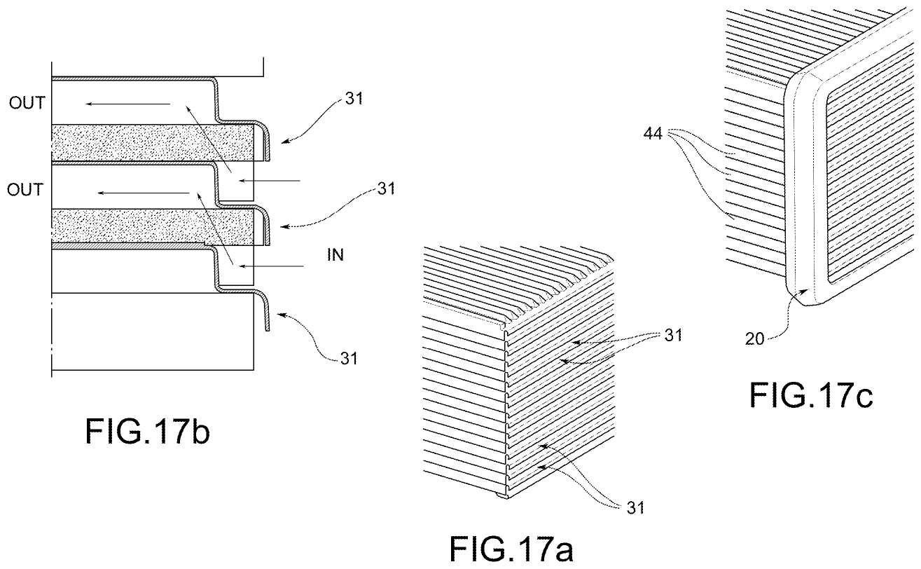

Preferably, similarly to the shaped portion described above, the baffle panel 4 comprises, in a region proximal to the inlet area INT, a portion shaped so as to have the sealing engagement on the first filtering panel 3 aligned along the vertical axis with the sealing engagement on the second filtering panel 3, thus fluidly closing the outlet chamber 6, but allowing the inlet into the inlet chamber 5 (as shown by way of example in FIGS. 17a, 17b and 17c).

In accordance with a preferred embodiment, the inlet filter edge 31 is clamped into the inlet housing cavity 411.

Therefore, the inlet edge portion 410 preferably closes and blocks the flow of the fluid crossing the thickness of the filtering panel 3.

In accordance with a preferred embodiment, the side baffle surfaces 44 sealingly engage the filtering panel 3.

In accordance with a preferred embodiment, the side baffle surfaces 44 sealingly engage the side edges 34 of the filtering panel 3.

Preferably, the inlet chamber 5 is thus closed on three sides at the side baffle surfaces 44 and at the outlet baffle edge 42.

Preferably, the outlet chamber 6 is thus closed on three sides at the side baffle surfaces 44 and at the inlet baffle edge 41.

According to a preferred embodiment, said side baffle surfaces 44 extend in height substantially parallel to the vertical axis V-V.

According to a preferred embodiment, each side baffle surface 44 comprises a support foot 440 substantially parallel to the imaginary plane F, suitable for sealingly engaging the filtering panel 3.

Preferably, the inlet baffle edge 41 and/or the outlet baffle edge 42 comprise respective support steps substantially parallel to the imaginary plane F suitable for sealingly engaging the filtering panel 3.

In accordance with a preferred embodiment, the side baffle surfaces 44 comprise a protruding side portion 441 suitable for extending beyond the filtering panel 3 on the opposite side with respect to that in which the coupling of the baffle panel 4 to the filtering panel 3 defines the inlet chamber 5. Preferably, the protruding side portion 441 of a baffle panel 4 is suitable for engaging the subsequent baffle panel 4 allowing the stacking thereof in the vertical direction. Preferably, the protruding side portion 441 of a baffle panel 4 is suitable for engaging the subsequent baffle panel 4 so that the mutual engagement between two baffle panels 4 is sealed (as shown by way of example in FIG. 15).

According to a preferred embodiment, the baffle panel 4 is positioned in the space between two filtering panels 3, so as to sealingly engage both the first filtering panel 3 and the second filtering panel 3 with the side baffle surfaces 44.

Preferably, the side baffle surface 44 is shaped so as to have the sealing engagement on the first filtering panel 3 aligned, along the vertical axis V-V, with the sealing engagement on the second filtering panel 3. In other words, the side baffle surfaces 44 also have a preferred shape similar to that shown with reference to the outlet regions in FIGS. 18a, 18b and 18c.

In accordance with a preferred embodiment, the baffle panel 4 is shaped comprising a plurality of alternate walls 40 suitable for defining a plurality of inlet channels 500 in the inlet chamber 5.

Preferably, each inlet channel 500 comprises an inlet mouth 501 proximal to the inlet area IN and a filtration section 502 facing the filtering panel 3.

Thereby, the fluid is channeled at the inlet along each inlet channel 500, up to the filtration section 502 facing the filtering panel 3.

According to a preferred embodiment, each alternate wall 40 is connected to the next alternate wall in a top portion 401 and is connected to the previous alternate wall in a bottom portion 402.

Preferably, said top portions 401 and/or said bottom portions 402 are mutually joined to each other in an arcuate manner.

In some preferred embodiments, said top portions 401 and/or said bottom portions 402 comprise specific support planes.

In accordance with a preferred embodiment, the respective bottom portions 402 of the baffle panel 4 rest on the filtering panel 3.

Preferably, the respective bottom portions 402 of the baffle panel 4 generally rest on a filtering panel 3.

In accordance with a preferred embodiment, the respective top portions 401 are engaged by a filtering panel 3.

Therefore, the baffle panel 4 also preferably acts as a reinforcement and support element for the filtering panels 3.

According to a preferred embodiment, the inlet channels 500 delimited by the baffle panel 4 have lengths which are different from one another, comprising primary inlet channels 500 which extend from the inlet area IN to a region which is proximal to the outlet area OUT.

According to a preferred embodiment, the inlet channels 500 delimited by the baffle panel 4 comprise auxiliary inlet channels 500 which extend from the inlet area IN to a region which is distal to the outlet area OUT.

According to a preferred embodiment, the baffle panel 4 comprises primary inlet channels 500 and auxiliary inlet channels 500.

According to a preferred embodiment, the inlet channels 500 delimited by the baffle panel 4 have a variable pitch along the transverse axis Y-Y (as exemplified in FIG. 12a, for example).

Preferably, the pitch of the inlet channels 500 is a function of the very nature of the aforesaid channels.

Preferably, for example, the pitch of the inlet channels 500 is a function of the length of the inlet channels 500 having baffle panel portions with a greater number of channels in the region in which there are inlet channels 500 of a length shorter with respect to baffle panel portions where primary inlet channels 500 of a greater length are present.

According to a preferred embodiment, the baffle panel 4 transversely alternates primary inlet channels and auxiliary inlet channels (as shown by way of example in FIG. 13f).

Such a preferred embodiment is particularly used on embodiments with filtering panels 3 having an extension with respect to longitudinal axes X-X or with respect to transverse axes Y-Y of a non-linear type, for example curvilinear.

In a completely similar but complementary manner, the same considerations described for the inlet channels 500 are present for the outlet channels 600 defined by the baffle panel 4: for example, where the inlet channels 500 have a course which decreases when decreasing in section, the outlet channels 600 expand when expanding the section thereof; for example, auxiliary outlet channels are at the location of primary inlet channels, and vice versa, primary outlet channels are at the location of auxiliary inlet channels.

According to a preferred embodiment, the inlet channels 500 have a constant section which is different from the constant section of the outlet channels 600.

Preferably, the passage section of each inlet channel 500 is greater than the passage section of each outlet channel 600.

Preferably, in this embodiment, the distribution of the fluid flowing towards the filtering panel 3 is improved and the dust accumulation effect by each filtering panel 3 of the filter group 1 is maximized, also reducing the pressure drops.

According to the preferred embodiment, with a filter group 1 having a cylindrical shape and a radial flow, the filtering panel 3 is in the shape of a disc.

According to such an embodiment, the baffle panel 4 is in the shape of a disc.

Preferably, the filtering panel 3 and the baffle panel 4 are mutually engaged defining an inlet chamber 5 of an annular shape.

Preferably, the filtering panel 3 and the baffle panel 4 are mutually engaged to define an outlet chamber 6 of an annular shape.

Preferably, the baffle panel 4 has channels oriented in the radial direction. Preferably, the baffle panel 4 defines inlet channels 500 oriented in the radial direction. Preferably, the baffle panel 4 defines outlet channels 600 oriented in the radial direction (as shown in FIGS. 13b to 13f).

According to an alternative embodiment, the baffle panel 4 defines passage channels with a spiral geometry in the inlet chamber 5 and/or in the outlet chamber 6 (as shown in FIG. 13e).

In accordance with a preferred embodiment, the alternate walls 40 have an incident course, so as to delimit inlet channels 500 with a tapered course.

In accordance with a preferred embodiment, the alternate walls 40 have an incident course, so as to delimit outlet channels with a tapered course.

According to a preferred embodiment, the baffle panel 4 or the alternate walls 40 comprise baffle elements 409, so as to delimit inlet channels 500 with a tapered course.

Preferably, the baffle elements 409 are suitable for acting as a chute for the fluid towards the filtering panel 3.

In accordance with a still further embodiment, the filter group 1 comprises a container body 2 suitable for containing the filtration region R, containing the at least one filtering panel 3 and the at least one baffle panel 4.

Substantially, the container body has such a shape as to identify the inlet area IN and the outlet area OUT to fluidly connect them by means of the filtration region R, inside which the filtering panels 3 and the baffle panels are housed 4.

Furthermore, according to a preferred embodiment, the container body 2 comprises a perimeter gasket 20 which extends about the at least one filtering panel 3 and the at least one baffle panel 4, so as to define the inlet area IN.

In accordance with the accompanying diagrams, and according to the relative specific needs of the designer, for example, according to the spaces present in the vehicle, some features described and shown in a preferred embodiment are also present in other embodiments.

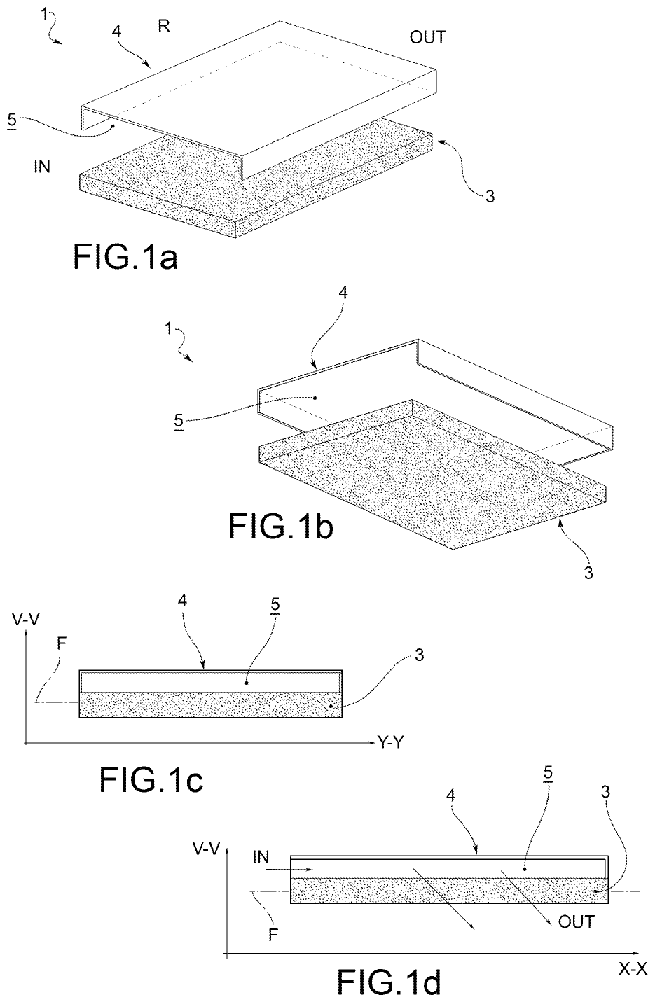

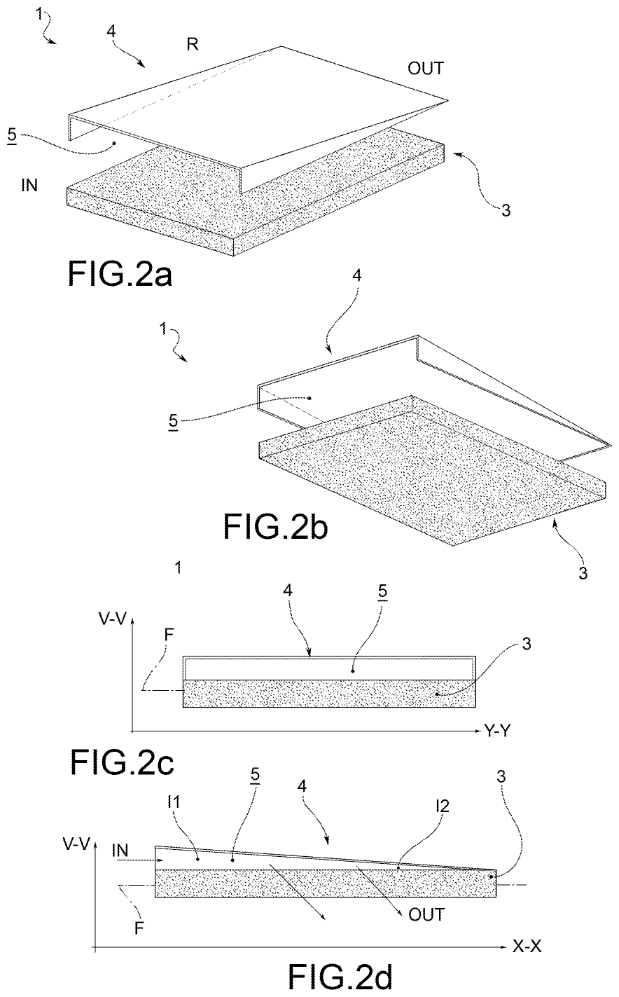

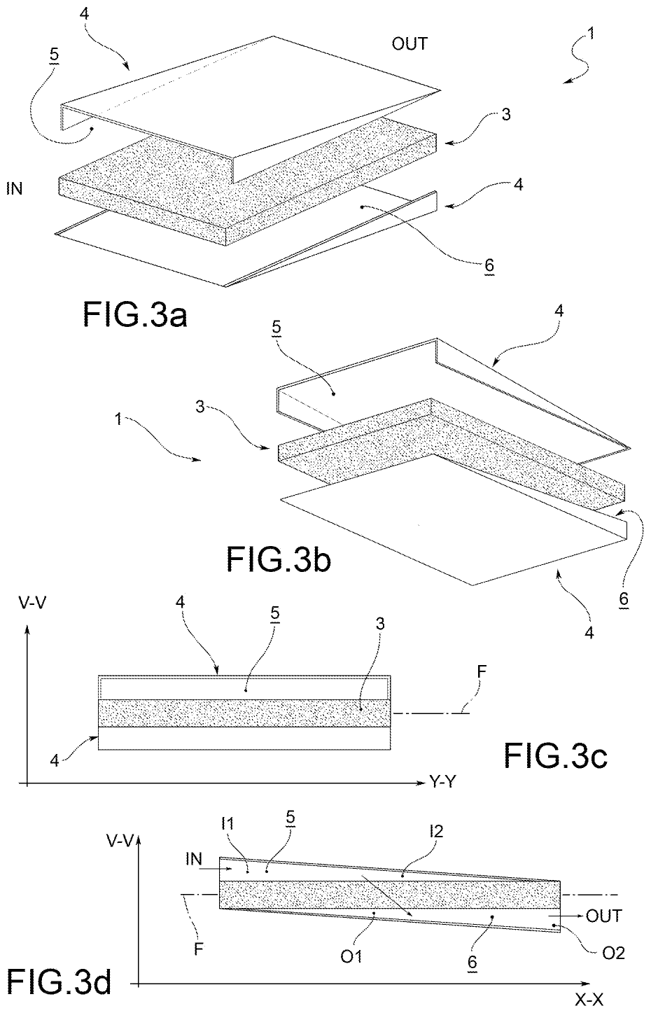

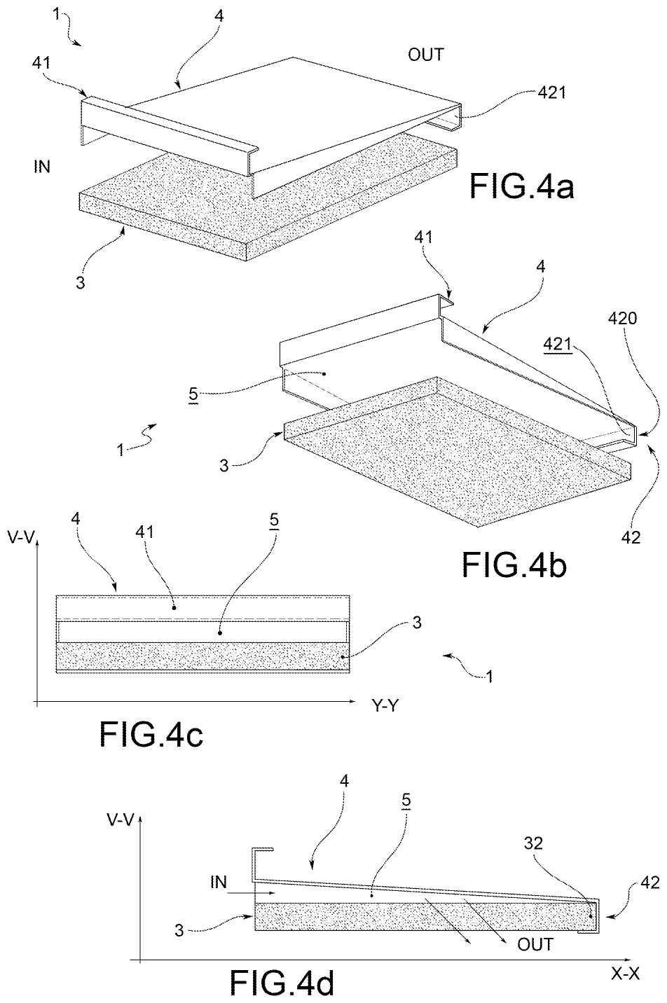

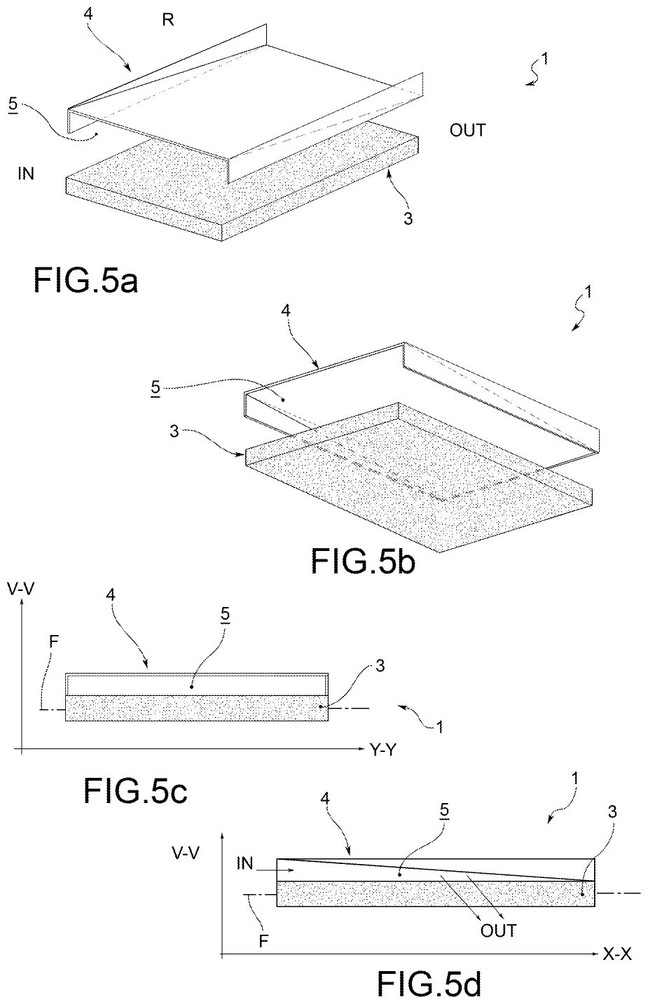

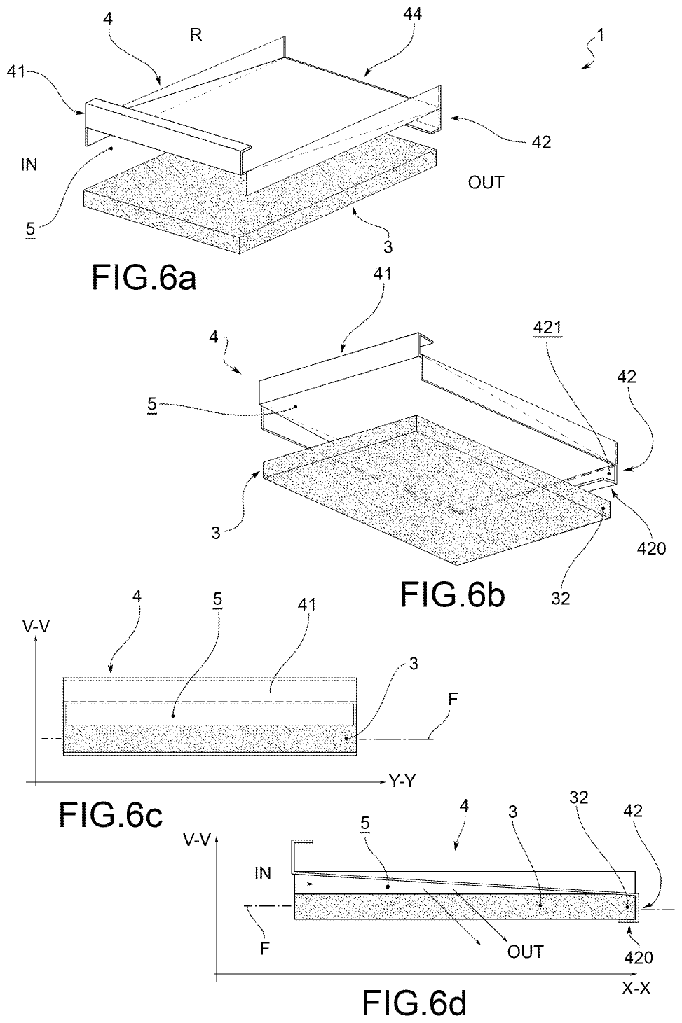

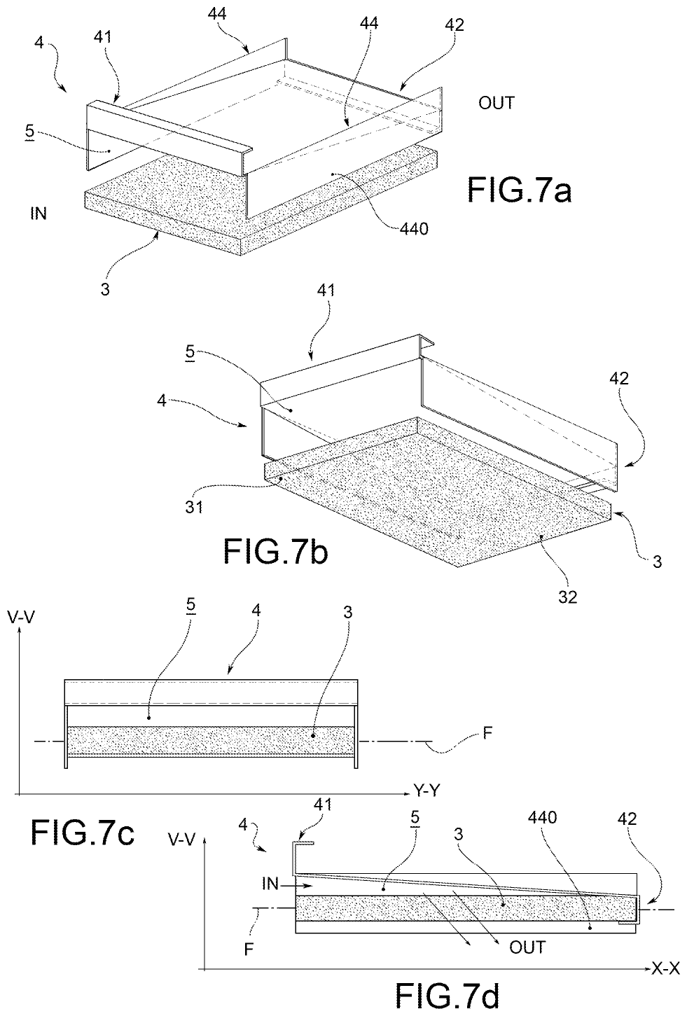

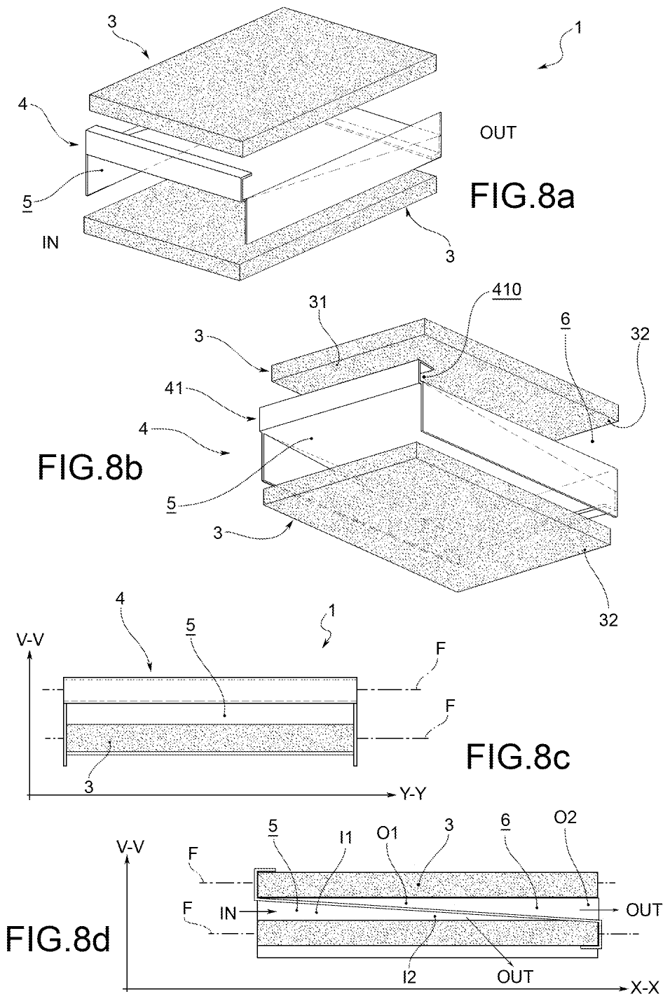

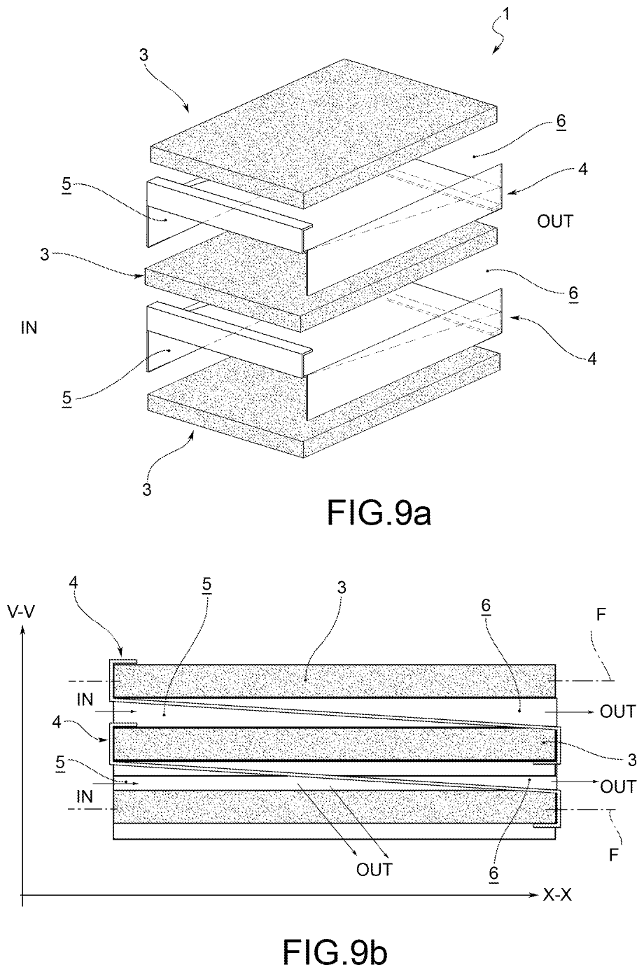

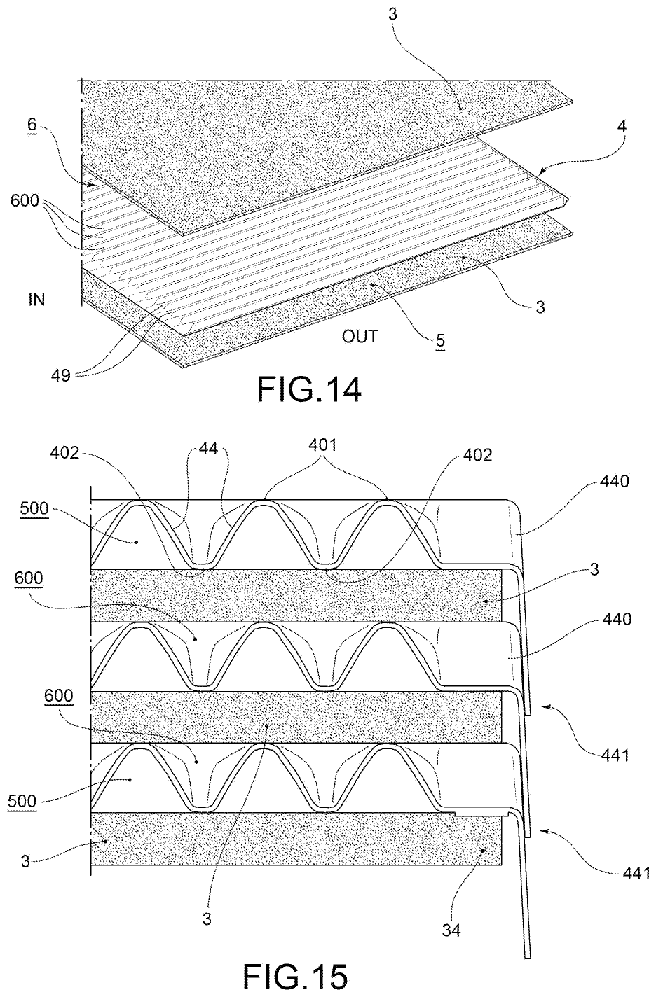

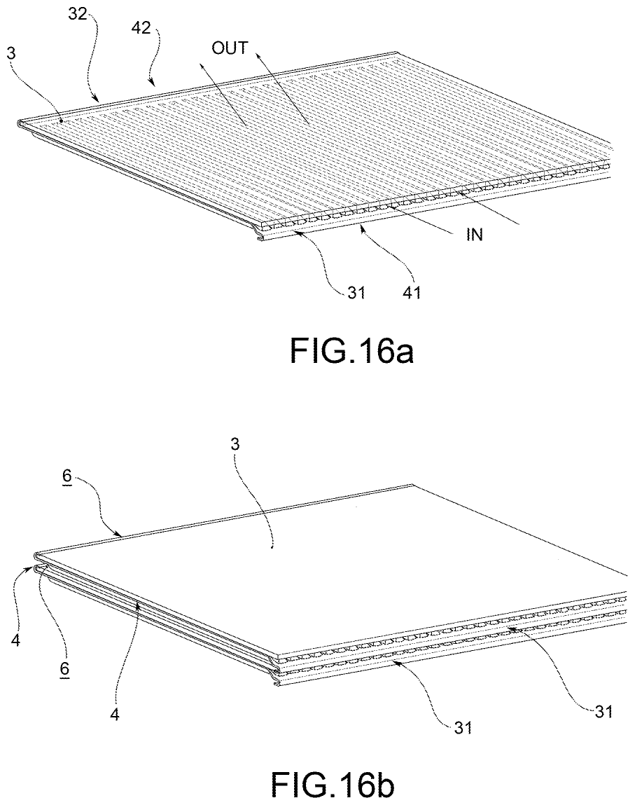

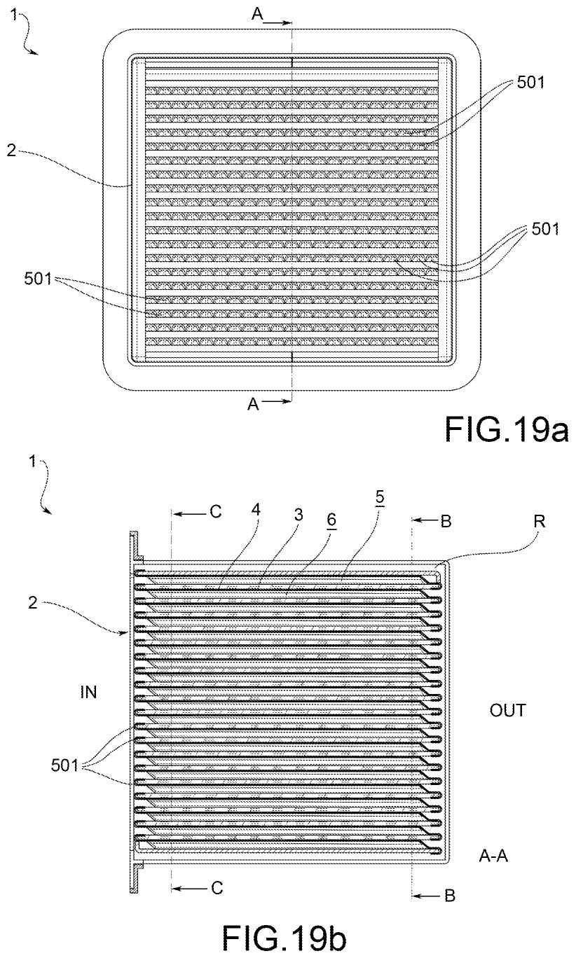

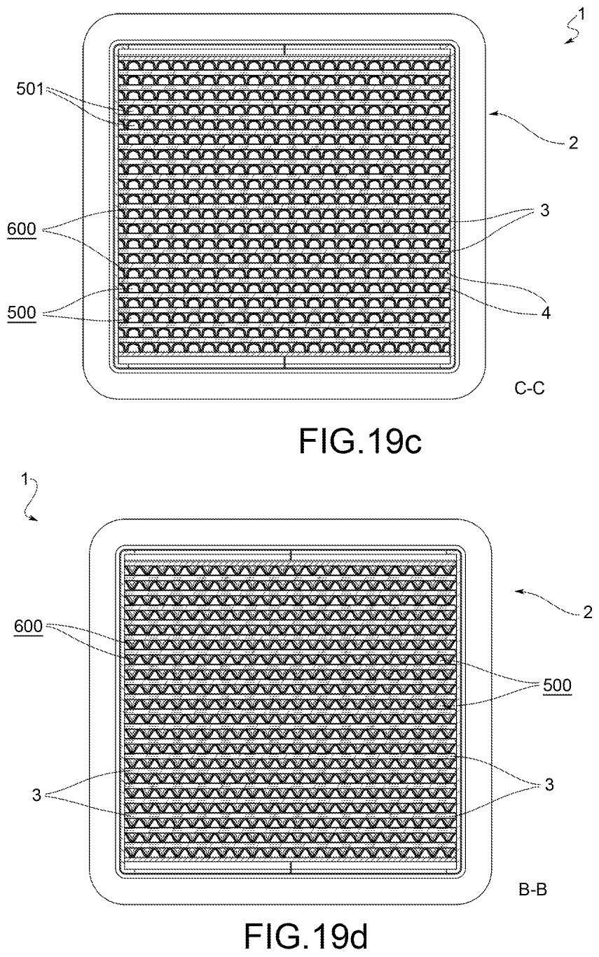

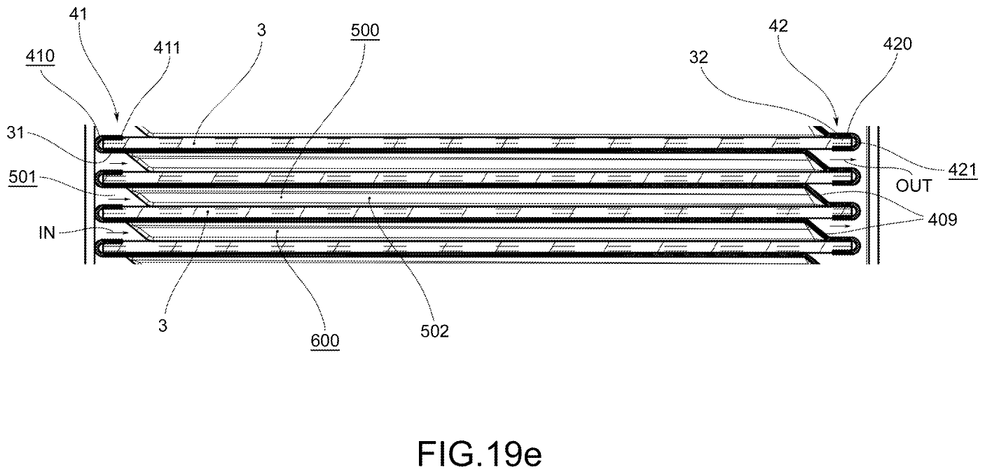

Preferably, in the diagrammatic Figures from FIG. 1 to FIG. 13f, the baffle panels 4 are shown substantially planar; although, according to the needs, they have the wavy shape described so as to be suitable for defining the respective inlet channels 500 and the respective outlet channels 600 described above as shown in FIGS. 14 to 19e.

Innovatively, the filter group largely fulfills the purpose of the present invention, overcoming issues which are typical of the prior art.

Advantageously, in fact, the filter group is suitable for filtering the fluid in a highly effective and efficient manner, not acting as an obstacle to the flow of the fluid, but rather favoring the motion thereof in a substantially main connection direction between the inlet area and the outlet area.

In fact, advantageously, the filter group has a wide inlet surface and a wide outlet surface while having however wide filtering surfaces.

Advantageously, the baffle panel favors the flow of the fluid at the inlet and favors the outflow of the fluid at the outlet. Advantageously, the baffle panel minimizes pressure drops imposed on the system in which it is installed.

Advantageously, the baffle panel distributes the flow rate of the fluid which strikes the filtering panel, improving the use of the available filtering surface.

Advantageously, the baffle panel gives solidity to the filter group.

Advantageously, the baffle panel comprises an inlet edge which engage the filtering panel, improving the fluid dynamics of the filter group, in particular, reducing the pressure drops at the entrance to the inlet chamber.

Advantageously, the baffle panel comprises an outlet edge which engage the filtering panel, improving the fluid dynamics of the filter group, in particular, reducing the pressure drops at the exit of the outlet chamber.

Advantageously, the baffle panel comprises edge portions which engage the filtering panel, simplifying the separation between each inlet chamber and each outlet chamber.

Advantageously, the filter group is modular and is simply adaptable to the design needs by taking advantage of all the above advantages.

Advantageously, the filter group allows to easily modulate the available filtering surface by selecting the number of filtering panels, baffle panels and/or by acting on the dimensions thereof, such as, for example, on the length thereof.

Advantageously, at the design level, the behavior of the filtering panel is easily and faithfully determinable so as to produce effective and efficient filter groups. Advantageously, performance losses of the filtering panel, conventionally due to bending/deformation operations, are avoided. In this solution, in fact, the filtering panel is used in the form of a flat sheet, similar to the experimental conditions in which it is tested and developed.

Advantageously, the filtering panels do not require multiple production operations, such as, for example, filtering panels comprising pleated paper filters.

Advantageously, the production costs of the filtering panels and filter group are highly low.

Advantageously, the filtering panels have a porous and permeable structure, thus managing to accumulate the contaminant in the thickness thereof.

Advantageously, the passage channels are formed on the baffle panel, keeping the structure of the filtering panel, on which no bending and/or deformation operations have to be performed, simple.

Advantageously, not having to undergo bending operations, the filtering panels have a permeable, bulky, and relatively thick filtering structure, which is utilizable for accumulating contaminants in the thickness of the filtering panel.

Advantageously, without needing to undergo folding operations, the filtering panels may have a multilayer structure, for example, comprising at least one filtering layer and at least one adsorbent layer, thus allowing to obtain a multifunctional filtering structure with relative simplicity, thus avoiding folding processes.

Advantageously, in the embodiment in which the filtering panel is made of hydrophobic synthetic fibers, preferably polypropylene, the resistance of the filter group to the treatment with humid and/or droplet-containing air is increased.

It is apparent that, in order to meet contingent needs, a person skilled in the art may make changes to the invention, all contained within the scope of protection as defined by the following claims.

### REFERENCE NUMERAL LIST

1 filter group
2 container body
20 perimeter gasket
3 filtering panel
31 inlet filter edge
32 outlet filter edge
34 filter side edge
4 baffle panel
40 alternate walls
401 top portions
402 bottom portions
41 inlet baffle edge
410 inlet edge portion
411 inlet housing cavity
42 outlet baffle edge
420 outlet edge portion
421 outlet housing cavity
44 side baffle surfaces
440 support foot
441 protruding side portion
49 baffle element
5 inlet chamber
500 inlet channel
501 inlet mouth
502 filtration section
6 outlet chamber
600 outlet channels
X-X longitudinal axis
Y-Y transverse axis
V-V vertical axis
IN inlet area
OUT outlet area
R filtration region
F imaginary plane
I1 first inlet area
I2 second inlet area
O1 first outlet area
O2 second outlet area
C central cavity

1. A filter group crossable under filtration by a fluid, preferably by air, wherein the filter group comprises a filtration region, which extends between an inlet area through which the fluid to be filtered flows, and an outlet area through which the filtered fluid flows, wherein the filter group extends along a longitudinal axis (X-X), along a transverse axis (Y-Y) and, in height, along a vertical axis (V-V);
wherein the filter group comprises:
a filtering panel, which extends with respect to an imaginary plane on which both the longitudinal axis (X-X) and the transverse axis (Y-Y) lie, wherein said filtering panel is crossable by the fluid under filtration in a direction substantially orthogonal to the imaginary plane substantially parallel to the vertical axis (V-V);
a baffle panel impermeable to fluid;
an inlet chamber defined between the filtering panel Wand the baffle panel, wherein the inlet chamber is open in a region proximal to the inlet area and is closed in a region proximal to the outlet area.

2. The filter group according to claim 1, comprising a couple of baffle panels impermeable to fluid, positioned at the two opposite faces of the filtering panel, wherein the first baffle panel and the filtering panel define said inlet chamber, wherein the filtering panel and the second deflector panel define an outlet chamber which is open in a region proximal to the outlet area and is closed in a region proximal to the inlet area.

3. The filter group according to claim 1, comprising a couple of filtering panels, wherein the baffle panel is positioned in the space between two filtering panels so that said inlet chamber is defined between the first filtering panel and the baffle panel, and so that an outlet chamber is defined between the second filtering panel and the baffle panel, wherein the outlet chamber is open in a region proximal to the outlet area and is closed in a region proximal to the inlet area.

4. The filter group according to claim 2, wherein the inlet area and the outlet area are spatially positioned as a function of the shape or position of the baffle panel which delimits the outlet chamber.

5. The filter group according to claim 1, wherein the longitudinal axis (X-X) extends in a linear direction and/or in a curvilinear direction and/or in a broken direction.

6. The filter group according to claim 1, wherein the transverse axis (Y-Y) extends in a linear direction and/or in a curvilinear direction and/or in a broken direction.

7. The filter group according to claim 1, comprising a central cavity, and the filtration region extends about the central cavity so that the outlet area corresponds to said central cavity and the inlet area is radially spaced apart from said outlet area.

8. The filter group according to claim 1, wherein the baffle panel is shaped comprising a plurality of alternate walls suitable for defining a plurality of inlet channels in the inlet chamber, wherein each inlet channel comprises an inlet port proximal to the inlet area and a filtration region facing the filtering panel.

9. The filter group according to claim 8, wherein each alternate wall is connected to the next alternate wall in a top portion and is connected to the previous alternate wall in a bottom portion.

10. The filter group according to claim 9, wherein the respective bottom portions rest on the filtering panel.

11. The filter group according to claim 9, wherein the respective top portions are engaged by a filtering panel.

12. The filter group according to claim 8, wherein the inlet channels delimited by the baffle panel have mutually different lengths, comprising primary inlet channels, which extend from the inlet area to a region proximal to the outlet area, and auxiliary inlet channels which extend from the inlet area to a region distal from the outlet area.

13. The filter group according to claim 8, wherein the inlet channels delimited by the baffle panel have a variable pitch along the transverse axis (Y-Y).

14. The filter group according to claim 8, wherein the alternate walls have an incident course, so as to delimit inlet channels with a tapered course.

15. The filter group according to claim 1, comprising a plurality of filtering panels and comprising a plurality of baffle panels stacked parallel to the direction of the vertical axis (V-V).

16. The filter group according to claim 1, wherein the filtering panel is a sheet-like filtering medium made of a single-layer or multi-layer porous filtering material.

17. The filter group according to claim 1, wherein the baffle panel is a non-permeable element made of a material belonging to the family of the plastic materials.

18. The filter group according to claim 16, wherein the filtering panel and/or the baffle panel contain adsorbent substances therein, such as activated carbon.
